(19) United States
(12) Patent Application Publication
(10) Pub. No.: US 2006/0271787 A1
(43) Pub. Date: Nov. 30, 2006

(54) System and method for validating a hard-copy document against an electronic version

(75) Inventors: Dennis C. DeYoung, Webster, NY (US); Warren D. Kleiman, Fairport, NY (US); Devin J. Rosenbauer, Butler, PA (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/140,688

(22) Filed: May 31, 2005

(51) Int. Cl. H04L 9/00

(52) U.S. Cl. 713/176; 713/181

(57) ABSTRACT

The disclosure recites methods for verifying that the authenticity of a hard copy document by verifying that a digital signature printed on that document matches the signature on the original electronic document. The method includes converting a physical manifestation of a digital signature affixed to the hard copy document to an electronic digital signature, validating the electronic digital signature via a public key to authenticate the hard-copy document, and comparing a message digest of the original electronic document to a message digest coded in the digital signature. It also includes documents having multiple digital signatures embedded using a variety of techniques, converting those printed digital signatures into electronic forms, and validating each electronic digital signature independently and against each other.

The exemplary embodiments disclosed herein relate generally to the authentication and non-repudiation of hard-copy communications. More particularly, the embodiments relate to an apparatus and method for the authentication and non-repudiation of hard-copy documents using a digital signature and/or a digital certificate.

Many business activities require execution of various documents, typically by signature. Signing such documents serves a number of purposes. A signature authenticates a document by associating the signer with the signed document. In certain contexts, the signature expresses the signer's approval or authorization of the document, or the signer's intention that it have legal effect. Such authentication also enables the receiver to prove to a third party, such as a judge, that the document was created by the purported sender. This latter ability prevents the sender from repudiating a genuine document, such as a promise to pay, by falsely claiming that it is a forgery created by the receiver. A signature on a written document often imparts a sense of clarity and finality to the transaction and may lessen the subsequent need to inquire beyond the face of a document. Negotiable instruments, for example, rely upon formal requirements, including a signature, for their ability to change hands with ease, rapidity, and minimal interruption. The act of signing a document calls to the signer's attention the legal significance of the signer's act, and thereby helps prevent inconsiderate engagements. Consequently, sound practice calls for transactions to be formalized in a manner that assures the parties of their validity and enforceability.

Until a few years ago, formalization generally involved documenting the transaction on paper and signing or authenticating the paper. Historically the written signature has been adequate in the majority of situations for purposes of verifying the authenticity of a document despite the realization that the document may have been subsequently modified, the signature could have been initially affixed to a blank piece of paper to which content was later added, or the possibility that the signature is a forgery. In other words, there is an inherent value in the written or “wet” signature that typically provides an adequate or even significant level of confidence in the authenticity of the document. Although the basic nature of transactions has not changed, business conditions have required an increasing reliance on digital documents. Ordinary digital documents lack the verifiable authenticity of paper documents in two respects. First, third parties claiming to be the purported sender can forge a digital document or subject the document to undetectable modification in transit. Second, the actual sender may falsely claim that the document is a forgery created by the receiver and later repudiate a genuine document.

Most modern office software allows the user to digitally sign documents so recipients may verify their integrity. Digital signatures have been used for some time on digital documents to provide the two main functions of an ink signature on a paper document, namely “authentication” and “non repudiation.” Most digital signature schemes use public key cryptography to provide authentication and non-repudiation for transmitted data. Typical digital signatures created via an asymmetric key algorithm can be validated by anyone knowing the public key of the sender.

Digital signatures remain useful while the document traverses an electronic workflow, such as between computers at an organization. However, when a user prints and distributes such a signed document, the paper copies do not typically retain any identifying or verifying information beyond that actually contained in the document text itself. In the past, a physical seal or watermark has been applied to the paper to verify authenticity. However, a seal or watermark can easily be faked, and does nothing to verify the integrity of the document's content. Also, most seals and watermarks do not survive the copying process. On the other hand, a digital signature or digital certificate (which can be interchanged depending on the level of trust desired and are therefore hereafter used interchangeably for the purposes of this description), allows verification of both the document's authenticity and the integrity of the document's content. Regarding the confidence of authenticity that a wet signature imposes on a document, the same, or even more confidence, could be attributed to a digital signature on a hard copy document because it is both harder to forge and tied in some way to the content of the document—even if only through signed document metadata, such as version and date information, and/or a message digest to the electronic version. Repeatedly attaching this signature to the document in increasingly integrated manners, such as interlacing the signature throughout the text, provides a method of cross-checking the validity and only adds to the confidence level achieved. If printed using a two-dimensional (2-D) barcode technology, in a manner detectable by scanners, such a printed digital certificate would provide both a visible and automatic verification method. Glyphs, such as, for example, XEROX DataGlyphs™ are an example of a two-dimensional barcode technology.

Embodiments include a method for verifying the authenticity of a hard copy document by verifying that a digital signature printed on that document matches the signature on the original electronic document. The method includes converting a physical manifestation of a digital signature affixed to the hard copy document to an electronic digital signature, validating the electronic digital signature via a public key to authenticate the hard-copy document, and comparing a message digest of the original electronic document to a message digest coded in the digital signature. It also includes, depending on the confidence level desired by the users, documents having multiple digital signatures embedded using a variety of techniques, converting those printed digital signatures into electronic forms, and validating each electronic digital signature independently and against each other.

Various exemplary embodiments will be described in detail, with reference to the following figures.

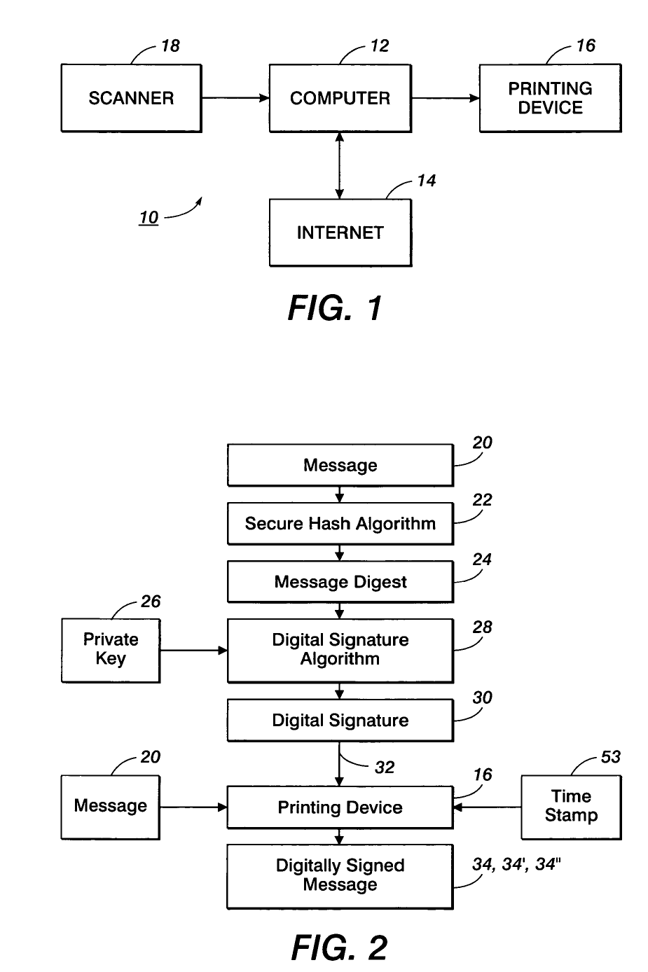

FIG. 1 is a schematic diagram of apparatus for creating a physical manifestation of the digital signature/digital certificate.

FIG. 2 is a flow diagram of a method for creating a physical manifestation of the digital signature/digital certificate.

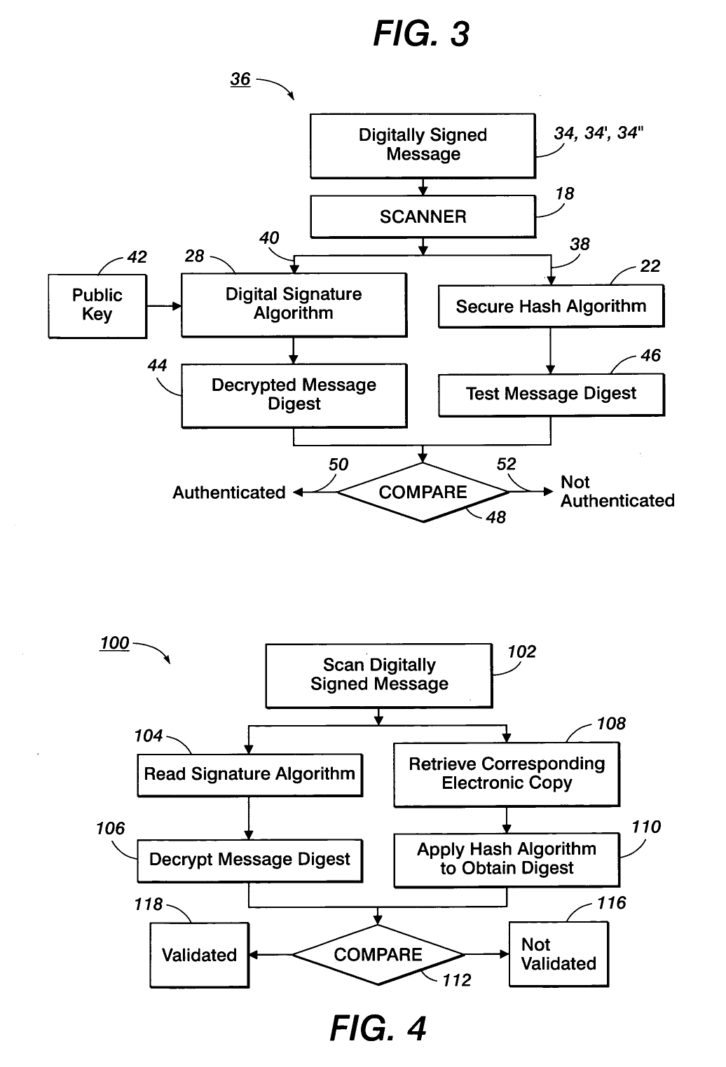

FIG. 3 is a flow diagram of a method for authenticating a physical manifestation of the digital signature/digital certificate.

FIG. 4 is a flow chart representing a first method for verifying the digital signature affixed to a document.

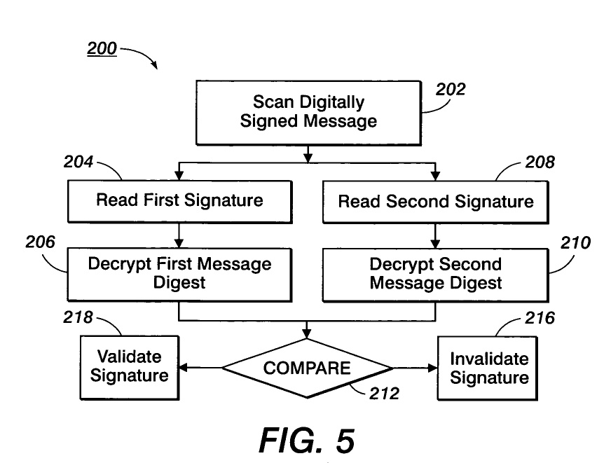

FIG. 5 is a flow chart representing a second method for verifying a digital signature.

With reference to the drawings wherein like numerals represent like parts throughout the several figures, and more particularly to FIG. 1, there is shown an apparatus 10 for creating a digital signature/certificate for use on a hard-copy document. The apparatus 10 comprises a computer system 12, including a keyboard, a display and a mouse (none of which are shown), and is connected to the Internet 14. In addition, the computer system 12 includes a printing device 16 and a scanning device 18, as explained in greater detail below.

The subject method for creating and affixing a digital signature to a hard-copy document provides a signature that may be used to indicate the identity of the person who signed the document and that is very difficult for another person to produce without authorization. In addition, the digital signature may include information that can be used to identify or describe the document and to verify that the document has not been altered. Such signer authentication and document authentication are essential ingredients of a non-repudiation service.

To digitally sign a document, one typically creates a message digest of the document and then a digital signature. A message digest is a mathematically generated and reasonably unique numeric representation of data created using a one-way hash algorithm on the document contents. This data cannot be decrypted, but can be compared with the message digest of a different set of data, a document for instance, to determine if the two are identical or not. Two identical documents will have identical message digests, but a single character different between the two results in a difference in the two message digests. To create a digital signature from a document's message digest, the message digest and the hash algorithm used to create it are encrypted using a private key. A digital certificate is a digital signature that is signed and distributed by a trusted third party.

A conventional digital signature is a large number represented in a computer as a sequence of binary digits called bits. The digital signature is computed using a set of rules and a set of parameters such that the identity of the signatory and integrity of the data can be verified. The Digital Signature Standard (DSS) is a cryptographic standard promulgated by the National Institute of Standards and Technology (NIST) in 1994. It has been adopted as the federal standard for authenticating electronic documents, much as a written signature verifies the authenticity of a paper document. Each user possesses a private and public key pair. Public keys are assumed to be known to the public in general while private keys are never shared. Signature generation makes use of the private key to generate a digital signature. Signature verification makes use of the public key, which corresponds to, but is not the same as, the private key. Anyone can verify the signature of a user by employing that user's public key. Only the possessor of the user's private key can perform signature generation.

With reference to FIG. 2, the document 20 that is to be digitally signed (hereinafter “the message”) is input into a secure hash function 22 to produce a condensed version of the message, hereinafter “the message digest” 24. The secure has function 22, the message digest 24 and the private key 26 are then input to the digital signature algorithm 28 to generate the digital signature 30. Other information, such as, for example, the time/date, the signer's name, version number, document control number a URL reference or a pointer to an original electronic version of the document in a repository, or any other desired metadata may also be input to the digital signature algorithm 28 before the digital signature is generated.

The document may also include a physical manifestation of a time stamp 53. The timing of a digital signature in relation to the operational period of a certificate is critical to the verification of the digital signature and message integrity. For example, a digital signature created after a certificate has expired, been revoked, suspended, or before it has been issued is not verifiable even if the certificate is or subsequently becomes valid. Similarly, the digital signature of a certification authority on a certificate issued by the certification authority must be created during the operational period of the certification authority certificate issued by the issuing authority higher in the hierarchy. A time-stamp on the certification authority's digital signature (or on the certificate or on internal auditable records of the certification authority) is thus critical to the verification of the certification authority's digital signature, and will also be a factor in determining the time and date when the certificate is issued, the beginning point of the certificate's operational period. A time-stamp 53 should be expressed in a form that clearly indicates its frame of reference so that time-stamps are universally comparable, notwithstanding different time zones and seasonal adjustments.

A digital certificate is a digital signature that has been signed and distributed by a trusted third party or by a chain of trust to a trusted third party. X.509 Certificates are the standard defined by the Internet Engineering Task Force (IETF). Examples of trusted third parties include such corporations as VeriSign™ and Thawte™. Just as conventional digital signatures are electronic documents, conventional digital certificates are also electronic documents. An example of a hard-copy digital certificate can be seen in U.S. application Ser. No. ______, filed May 18, 2005 by Robert H. Sperry et al, DIGITAL SIGNATURE/CERTIFICATE FOR HARD-COPY DOCUMENTS (Attorney Docket No. 20041160-US-NP), herein incorporated by reference in its entirety for its teachings.

A physical manifestation of the digital signature is then affixed 32 to a hard copy of the document. The term “physical manifestation of the digital signature” is hereby defined as a machine readable format bound to the document, such as through printing, having a capacity sufficient to display the complete data content of a digital signature meeting the criteria of applicable industry standards.

One such physical manifestation is a printed representation of the digital signature in a 2-D barcode. Two-dimensional (2-D) symbologies first appeared in 1988 when Code 49 was introduced by Intermec. Two-dimensional barcodes can be classified into several types, with stacked and matrix being the most prevalent. Some of the advantages of 2-D over one-dimensional (1-D) barcodes are the physical size, storage capability and data accuracy. One example of a 2-D barcode is Adobe's PDF-417 2-D barcode. Glyphs are another example of a 2-D barcode, such as, for example, Xerox DataGlyphs™.

In addition to 2-D barcode methods, there are other ways a message digest may be digitally encoded into a document. For example, the digital signature might be hidden within and throughout the document content itself. The digital signature may be embedded in the text or images of the document. Alternatively, just the message digest could be encoded in this way throughout the document content. Several methods of hiding a digital code within printed text, including variation of font size, variation of letter spacing, and other techniques, have already been patented (e.g., U.S. application Ser. No. 10/057,297, filed Jan. 25, 2002, Publication No. 20030145206 A1, published Jul. 31, 2003 by Jack Wolosewicz et al, DOCUMENT AUTHENTICATION AND VERIFICATION, incorporated herein in its entirety for its relevant teachings). Viewed by the average person, the hidden code may be invisible or barely noticeable such that they do not attract the recipient's attention or affect perception of the document. The message digest could also be encoded along the edges of components within an image. Another way to include a signature would be to hide it in the gloss of a document. This could either be present in a gloss coating or in the natural gloss of the text or image. In the latter method, the gloss is typically controlled through half-toning methods. See U.S. application Ser. No. 10/876,001, filed Jun. 24, 2004 by Chu-Heng Liu et al, ENHANCEMENT OF GLOSSMARK IMAGES AT LOW AND HIGH DENSITIES (Attorney Docket No. A1742-US-NP) and U.S. application Ser. No. 10/186,065, filed Jun. 27, 2002, Publication No. 20040000786, published Jan. 1, 2004 by Beilei Xu et al, VARIABLE GLOSSMARK (Attorney Docket No. A1745-US-NP), herein incorporated by reference in their entirety. Xerox uses this technique for Glossmarks™. The technique used to produce Glossmarks™ can produce gloss images that are barely detectable or completely undetectable by the human eye, but could be picked up by a sufficiently powerful scanner. In either case, where the signature was embedded in gloss, the recipient could either use a special reader to scan an encrypted signature. Regardless of how it is encoded, the hidden digital code spread throughout the document contents should contain the same original message digest.

When using the method consisting of a digital signature or message digest encoded throughout the document contents, depending on circumstances, the modified text could either be generated at the application level (within an application such as Microsoft Word), at the printer code level (when the print job is generated in XML, PostScript, or some other printer definition language), or in the printer hardware itself at print time. The level at which the process is implemented might depend on a desire for secrecy either in transmission or in the existence of the key itself. (For instance, if the printed document contains the username of the person who printed it, a security auditor might not want him to know this.) All of these settings could be determined automatically by a program or by a manual configuration available to the user.

The task of affixing 32 a physical manifestation of the digital signature to a hard copy of the document may be performed in a number of ways. The digital signature 30 may be appended to the message 20 and the combined files 20, 30 transmitted to the printing device 16, such that the message 20 and the physical manifestation of the digital signature are printed as a single document 34. Appending the digital signature 30 can be implemented as a plug-in to a document creation application, Microsoft Word for example, that allows you to add the digital signature 30 to a document or locate it on a sheet of paper and then combine it the with the original document 20 either by electronic or manual methods. The message 20 and digital signature 30 may be transmitted sequentially to the printing device 16. In this case, the message 20 and the physical manifestation of the digital signature may be printed as a single document 34, with the physical manifestation of the digital signature/document being overprinted on the document/physical manifestation of the digital signature, or as separate message and signature documents 34, with the signature document being physically appended to the message document. The physical manifestation of the digital signature 30 may be printed on a label that is then physically affixed to the document 34. The digital signature may also be used to manufacture a rubber stamp that is used to create the physical manifestation of the digital signature in a known manner.

With reference to FIG. 3, the receiver authenticates 36 the digital signature 30 and the document 20 by scanning the physical manifestation of the digital signature and the document 34, to create a digital message file 38 and a digital signature file 40. The digital signature file 40 and the originators public key 42 are inputted into the digital signature algorithm 28, which decrypts the digital signature, producing a decrypted message digest 44. The receiver then inputs the digital message file 38 into the same hash function 22 as was used by the originator, to produce a test message digest 46. The review compares 48 the decrypted message digest 44 to the test message digest 46. If the test message digest 46 is identical to the decrypted message digest 44, the message is authenticated 50. If not, the message is not authenticated 52.

It may be desirable to have a method to verify that the scanned digital signature is original and not based upon an altered document. A sender or recipient of the document may want a secondary method of validating the signature. It is also possible that a document could be intercepted and altered and a new forged digital signature affixed to the altered document. There are multiple methods by which this may be accomplished, such as, for example, verifying that the document's message digest matches that of an original version stored in a secure document repository and verifying the first hard-copy digital signature against another hard-copy digital signature.

In embodiments, a document with a hard copy digital signature could be associated with a corresponding electronic version. If the recipient has access to an electronic version of the document then the recipient can access that document and compare its message digest (either computed on the fly or stored with the document) with the message digest scanned from the hard copy digital signature. One method for granting access would be to give the recipient a repository pointer (such as a URL, for example) and/or delegated credentials (either of which could also be hidden in the meta-data encoded in the barcode on the paper version). Delegated credentials can include, for example, access keys, usernames, passwords, or session keys. The hash function can be applied to the electronic version of the document, thereby creating a message digest for the electronic document. This digest can be compared to the one decrypted from the hard copy signature. If they are the same, the signature is valid and if not, the signature is not valid.

The hard-copy digital signature could be made by any method for encoding a signature into a document (such as, for example, 2-D barcode, altered images or text, and Glossmarks™ as described herein).

The electronic version may be stored in an archive or document database. Alternatively, the creator of the corresponding document version could retain a copy securely in storage. This would include, for example, storage on a secure hard drive, CD, DVD, or memory stick.

Note that this method does not preclude a malicious actor from changing the text of the document during the workflow, although with an electronic copy, one could visually compare the two documents before accepting the printed version. To verify the integrity of the document contents unconditionally, the recipient could print the document from the electronic version referenced and use that.

In some cases, the recipient may not want to access or may not have access to an electronic version of the printed document. In such cases, the creator of the document may digitally sign the hard copy in more than one manner. When the recipient compares the two and finds them to be identical, he will have verified the integrity of the document contents and authenticity of the document. If someone tampers with the visible text, the hidden digital code will no longer produce an identical message digest, and the document cannot be validated.

As previously described, these signatures may be encoded, for example, in 2-D barcodes, alterations to the text or images, or the gloss of the document. Other methods that allow the embedding of hidden information into a document may be used as well. The more signatures encoded into the document, the greater will be the recipient's confidence level in the document.

An additional level of verification could be achieved by also comparing multiple message digests, including that retrieved from the electronic version of the document via the reference in the meta-data encoded with the digital signature, and any or all hard-copy digital signatures embedded in the document.

FIG. 4 is a flow chart representing a first method 100 for verifying the digital signature affixed to a document. In this case, the message digest of the electronic version can be compared to that of the hard-copy document. Access to the electronic version of the document may be obtained through direct access to a repository or through an access code or a pointer included in the hard-copy digital signature. The recipient of the document first scans the document 102, and including the hard-copy signature thereon. The digital signature may be encoded in any of the physical manners described herein. The scanned signature is read 104 and the information therein, including the message digest, is decrypted 106. The electronic version of the document is also retrieved 108. Depending on the specific circumstances, retrieval of the electronic version can occur before, after, or at the same time as the hard-copy signature is read and decrypted. The same hash algorithm used to create the message digest contained in the hard-copy signature is then used on the electronic version to create a message digest for the electronic version 110. In embodiments, the hash algorithm is obtained from the hard-copy digital signature. The decrypted message digest from the hard copy and the newly created message digest are then compared 112. If they are the same, then the signature is validated 114 and if they are different, the signature is not validated 116.

FIG. 5 is a flow chart representing a second method 200 for verifying a digital signature. In this case, two or more digitally encoded signatures are present in the hard copy. The recipient of the document first scans the document 202, including the hard-copy signatures thereon. The scanned signatures are read 204, 208 and the information therein, including the message digest, are decrypted 206, 210. The digital signatures may be encoded in any of the physical manners described herein. Typically, one of the hard-copy signatures will be in the form of a 2-D bar code. After the message digest is obtained from each signature, the two may be compared 212 to help ensure that substantially all significant alterations to the text were not made. If they are the same, the signatures are validated 214 and if they are different, the signatures are not validated 216.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention. All patent applications, patents and other publications cited herein are incorporated by reference in their entirety.

What is claimed is:

1. A method for verifying the authenticity of a hard-copy document matches the signature on the original electronic document, comprising:
converting a physical manifestation of a digital signature affixed to the hard-copy document to an electronic digital signature;
validating the electronic digital signature via a public key to authenticate the hard-copy document; and.
comparing a message digest of the original electronic document to a message digest coded in the digital signature.

2. The method of claim 1, wherein the physical manifestation includes a 2-D bar code.

3. The method of claim 2, wherein the 2-D bar code includes glyphs.

4. The method of claim 1, wherein the physical manifestation includes alterations made to the text of the document.

5. The method of claim 1, wherein the physical manifestation of a digital signature affixed to the hard-copy document contains information needed to access the electronic version of the document.

6. The method of claim 5, wherein the physical manifestation of a digital signature affixed to the hard-copy document contains delegated credentials for accessing the document.

7. The method of claim 5, wherein the physical manifestation of a digital signature affixed to the hard-copy document contains a repository pointer for accessing the document.

8. The method of claim 1, wherein the hard-copy document contains at least two different types of physically manifested digital signatures, wherein each signature includes a message digest.

9. The method of claim 8, wherein comparing the message digest of the original electronic document to a message digest coded in the digital signature includes comparing the message digest of the electronic version to each encoded message digest of each physically manifested digital signature.

10. A method for authenticating and verifying a hard-copy of a document, comprising:
reading a first physical manifestation of a digital signature affixed to the document;
reading a second physical manifestation of the digital signature affixed to the document; and
comparing the read first physical manifestation of the digital signature to the read second physical manifestation of the digital signature to authenticate the document.

11. The method of claim 10, wherein the document includes more than two physical manifestations of the digital signature.

12. The method of claim 10, wherein comparing the read first physical manifestation to the read second physical manifestation includes comparing the message digest included in the first physical manifestation with the message digest included in the second physical manifestation.

13. The method of claim 10, wherein at least one of the first and second physical manifestations includes a 2-D bar code.

14. The method of claim 13, wherein the 2-D bar code includes glyphs.

15. The method of claim 13, wherein the other of the first and second physical manifestations includes alterations made to the text of the document.

16. The method of claim 13, wherein the other of the first and second physical manifestations is encoded in the gloss of the document.

17. A document, comprising:
a first encoded digital signature, and
a second encoded digital signature.

18. The document of claim 17, further comprising a third encoded digital signature.

19. The document of claim 17, wherein the first and second signatures contain the same information.

20. The document of claim 17, wherein the first digital signature is encoded by a first method and the second digital signature is encoded by a second method.

21. The document of claim 19, wherein one of the two signatures is encoded in a 2-D bar code.
